(19) United States
(12) Patent Application Publication
(10) Pub. No.: US 2016/0167270 A1
(43) Pub. Date: Jun. 16, 2016

(54) CARBON FIBER REINFORCED POLYMER PLATE AND MANUFACTURING METHOD

(71) Applicants: Hyundai Motor Company, Seoul (KR); LG Hausys, Ltd., Seoul (KR)

(72) Inventors: Huen Sick Min, Hwaseong (KR); Kyung Bum Kang, Bucheon (KR); Jong Soo Kim, Seoul (KR); Hee June Kim, Daejeon (KR); Kyung Hoon Lee, Anyang (KR); Tae Hwa Lee, Gwangmyeong (KR)

(21) Appl. No.: 14/739,080

(22) Filed: Jun. 15, 2015

(30) Foreign Application Priority Data
Dec. 15, 2014 (KR) 10-2014-0180596

(51) Int. Cl. B29C 45/14; B32B 5/18; B32B 15/04; B32B 3/26

(52) U.S. Cl. CPC B29C 45/14778; B32B 3/266; B32B 5/18; B32B 15/046; B29C 45/1459; B32B 2262/106; B32B 2305/022; B29L 2009/003

(57) ABSTRACT

A CFRP plate having a steel plate wherein a weld nut is welded is integrally stacked, and a manufacturing method are provided. The CFRP plate is formed by interposing a steel plate having a weld nut welded to a lower surface between two adjacent CFRP layers. A foam is interposed between a layer when the steel plate is disposed and a layer below the layer when the steel plate is disposed. The guide pins are fitted into the steel plate, a second layer, and the foam, forming an aperture in a portion of a second layer where the weld nut is positioned. A grove is formed accommodating the weld nut in the foam positioned below the aperture. A resin is injected when a temporary bolt is fitted into the weld nut, and the temporary bolt is removed after the resin is injected.

### CROSS-REFERENCE TO RELATED APPLICATION

This application is based on and claims the benefit of priority to Korean Patent Application No. 10-2014-0180596, filed on Dec. 15, 2015 in the Korean Intellectual Property Office, the disclosure of which is incorporated herein in its entirety by reference.

### TECHNICAL FIELD

The present disclosure relates to a Carbon Fiber Reinforced Polymer plate (hereinafter “CFRP plate”) and a manufacturing method of the CFRP plate. More particularly, to a CFRP plate on which a steel plate has a weld nut is welded is integrally stacked, and a manufacturing method thereof.

BACKGROUND

In general, a weld nut is a nut that is integrally welded to a plate. The weld nut is used in several cases such as when a nut may not be positioned at a required position or when a hand does not arrive at the required position when the nut is coupled to a bolt. In other words such a case may be required to automate a process of connecting the bolt and the nut to each other.

FIG. 1 is an exemplary cross-sectional view illustrating a weld nut structure according to the related art. The structure illustrated in FIG. 1 is a complex structure which precludes a nut from being inserted and fixed into the opposing surface of the member from the exterior. For example, in the structure a panel 80 and a member 90 may be coupled to each other while forming a closed cross section as illustrated in FIG. 1. Therefore, a weld nut 70 is first welded to the member 90, and the member 90 and the panel are spot-welded (S) to each other.

FIG. 2 is an exemplary view illustrating a sequence of a CFRP stack type molding method according to the related art. As illustrated in FIG. 2, a resin (eg. an adhesive) is injected into CFRP fibers tailored for a shape in advance of the injection and stacked in a mold. The air remaining in the mold is pushed out by the resin, and the resin is then when the resin and the CFRP are filled in an entire space within the mold. Finally, a desired shape is obtained when the cured resin is removed.

To prevent significantly change to a manufacturing process when a vehicle is manufactured using a CFRP plate as compared with when the vehicle is manufactured using a steel sheet, a weld nut structure is used for both manufacturing the vehicle using the steel sheet and the CFRP plate. However, the CFRP is not a material that may be welded, and when the resin is injected the nut is inserted together with the CFRP fibers into the mold as illustrated in FIG. 2, the nut is filled with the resin, such that the nut may not be used.

The above information disclosed in this section is merely for enhancement of understanding of the background of the invention and therefore it may contain information that does not form the prior art that is already known in this country to a person of ordinary skill in the art.

### SUMMARY

The present disclosure provides a CFRP plate structure to which a weld nut structure may be applied, and a method of manufacturing the CFRP plate. According to an exemplary embodiment of the present disclosure, a CFRP plate may be formed by interposing a steel plate to which a weld nut may be welded between adjacent CFRP layers adjacent to each other and injecting a resin when a temporary bolt is fitted into the weld nut. A foam may be interposed between a layer on which the steel plate is disposed and a layer disposed below the layer on which the steel plate is disposed. In addition, guide pins may be fitted into the steel plate, a second layer, and the foam. The weld nut may be interposed between two layers and the weld nut may be welded to a lower surface of the steel plate, an aperture may be formed in a portion of a second layer in which the weld nut may be positioned, and a groove that accommodates the weld nut therein may be formed in the foam positioned below the apertures. In addition, a third layer may have an aperture formed therein, the aperture having the temporary bolt penetrating therethrough. The temporary bolt may be removed after the resin is injected.

According to another exemplary embodiment, a manufacturing method of the CFRP plate may include: stacking at least two CFRP layers between a lower mold and an upper mold and interposing the steel plate having the temporary bolt that the weld nut may be fitted into is welded between the two layers; closing the mold and injecting the resin; and opening the mold and removing the temporary bolt, after the injecting of the resin. In the stacking of the at least two CFRP layers, the two CFRP layers may be stacked with the foam interposed between the layer on which the steel plate is disposed and the layer disposed below the layer on which the steel plate is disposed. Guide pins may be fitted into the steel plate, a second layer, and the foam.

Further, the steel plate may be stacked between the two layers and the weld nut may be fitted into the aperture of the portion of the second layer and the groove of the foam that corresponds to the aperture. A third layer may have an aperture formed therein; which may have the temporary bolt penetrating therethrough.

### BRIEF DESCRIPTION OF THE DRAWINGS

The above and other objects, features and advantages of the present disclosure will be more apparent from the following detailed description taken in conjunction with the accompanying drawings.

FIG. 1 is an exemplary embodiment of a cross-sectional view illustrating a weld nut structure according to the related art;

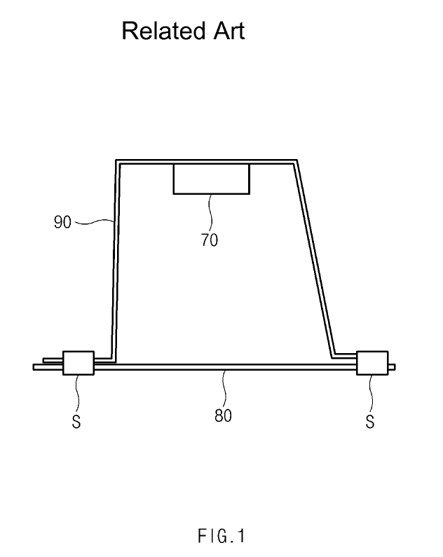

FIG. 2 is an exemplary embodiment of a view illustrating a sequence of a CFRP stack type molding method according to the related art;

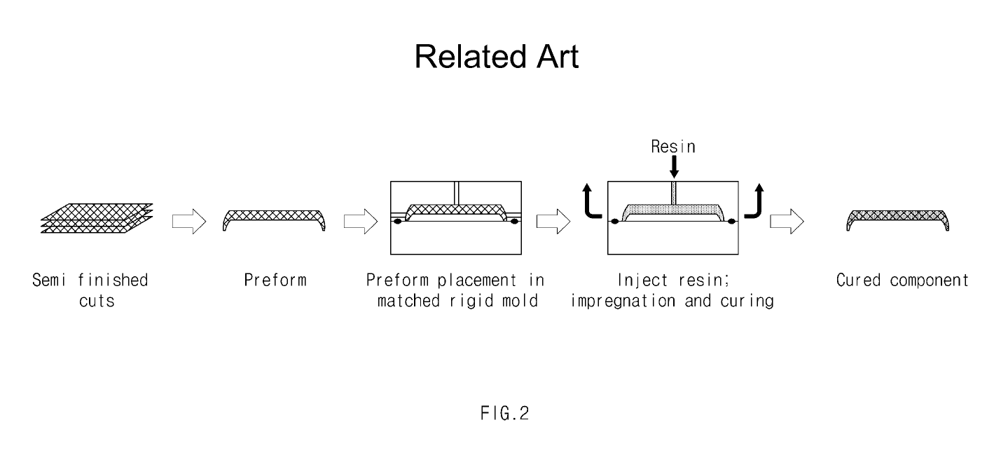

FIG. 3 is an exemplary embodiment of a view illustrating a CFRP closed cross-section member according to an exemplary embodiment of the present disclosure; and

FIG. 4 is an exemplary embodiment of a cross-sectional view illustrating a state in which a steel plate to which a nut plate is welded is integrally stacked within the CFRP closed cross-section member of FIG. 3 and taken along line a-a according to an exemplary embodiment of the present disclosure.

### DETAILED DESCRIPTION

The terminology used herein is for the purpose of describing particular embodiments only and is not intended to be limiting of the invention. As used herein, the singular forms “a”, “an” and “the ” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/of” includes any and all combinations of one or more of the associated listed items. For example, In order to make the description of the present invention clear, unrelated parts are not shown and, the thicknesses of layers and regions are exaggerated for clarity. Further, when it is stated that a layer is “on” another layer or substrate, the layer may be directly on another layer or substrate or a third layer may be disposed therebetween.

Hereinafter, exemplary embodiments of the present disclosure will be described with reference to the accompanying drawings. However, the drawings to be described below and the following detailed description relate to one exemplary embodiment of various exemplary embodiments for effectively explaining the characteristics of the present invention. Therefore, the present invention should not be construed as being limited to the drawings and the following description.

Further, in the following exemplary embodiments, the terminologies are appropriately changed, combined, or divided so that those skilled in the art may clearly understand them, in order to efficiently explain the main technical characteristics of the present invention, but the present invention is not limited thereto.

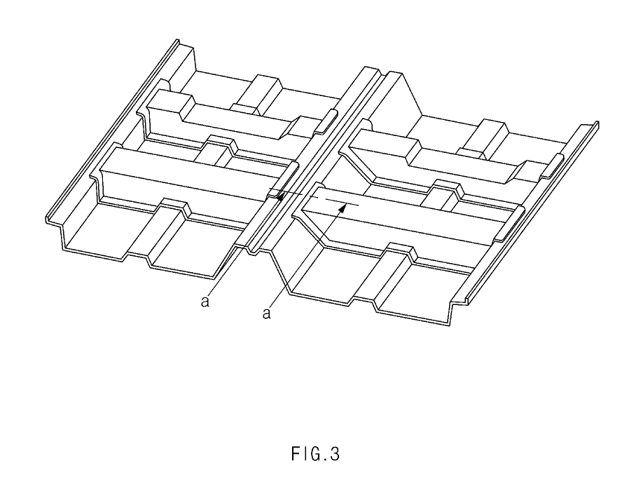

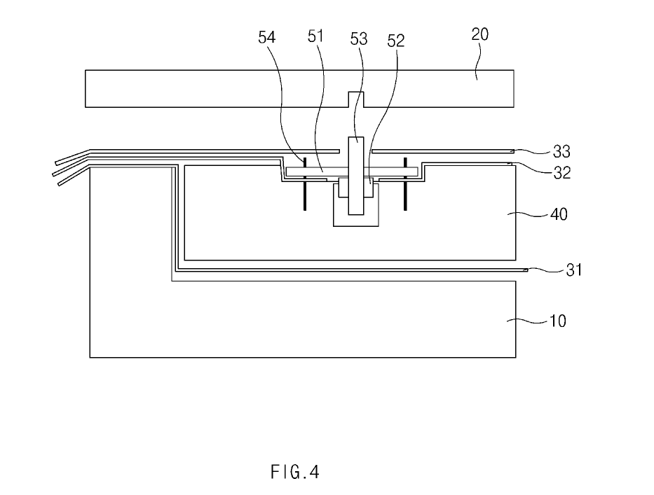

FIG. 3 is an exemplary view illustrating a CFRP closed cross-section member according to an exemplary embodiment of the present disclosure, and FIG. 4 is an exemplary cross-sectional view illustrating a state in which a steel plate to which a nut plate is welded is integrally stacked within the CFRP closed cross-section member of FIG. 3 and taken along line a-a.

Referring to FIG. 4, a CFRP plate according to an exemplary embodiment of the present disclosure may be manufactured by stacking a first CFRP layer 31, a second CFRP layer 32, and a third CFRP layer 33 in a space between a lower mold 10 and an upper mold 20. In addition, in the present disclosure, to integrally and firmly mold a weld nut that is to be integrally molded at an accurate position, the weld nut 52 may not be singly inserted, but may be inserted in a form which may be welded to a steel plate 51. Further, the weld nut 52 may be inserted when a central portion thereof is empty, a resin may flow into a hollow part of the weld nut, to clog the hollow part, and a part for approaching the nut aperture from an exterior surface of the CFRP plate may also be clogged. As a result, the weld nut may not be used.

Therefore, in the present disclosure, a process of injecting the resin may be performed when a temporary bolt 53 is temporarily connected to the weld nut as illustrated in FIG. 4. In particular, the process may be performed in a form having an upper portion of the temporary bolt 53 that may protrude outwardly while penetrating through the third CFRP layer that may form the exterior surface of the CFRP plate, as illustrated in FIG. 4. A groove that accommodates a protrusion part of the temporary bolt therein may be formed in the upper mold and the temporary bolt may be later separated from the exterior surface of the CFRP plate.

Furthermore, the weld nut may be disposed at a desired position, as illustrated in FIG. 4. A foam 40 that supports a lower surface of the steel plate 51 and having a groove formed therein to accommodate the weld nut welded to the lower surface of the steel plate 51 therein may be interposed between the first CFRP layer and the second CFRP layer in the vicinity of (e.g. adjacent to) a portion with which the weld nut is to be integrally molded. The second CFRP layer may be stacked on the foam 40, and the steel plate 51 and the weld nut 52 may be stacked on the second CFRP layer. Additionally, the foam may be made of a polypropylene material.

Moreover, to more accurately maintain the positions of the stacked steel plate and weld nut, guide pins 54 may be fitted into the steel plate 51, the second CFRP layer 32, and the foam 40. As illustrated in FIG. 4, at least two guide pins may be fitted more accurately maintain the positions. The third CFRT layer may be stacked, and the resin may be injected to mold a desired shape. After the shape is molded, the temporary bolt 53 may be removed. In other words, the CFRP plate having a shape as illustrated in FIG. 3 may be manufactured.

A manufacturing method of a CFRP plate according to the exemplary embodiment of the present disclosure will be further described. First, the mold may be opened, and the first CFRP layer 31 may be stacked on the lower mold 10. Then, the foam may be arranged and stacked on the first CFRP layer 31 based on the mold, and the second CFRP layer 32 may be stacked on the foam. For example, an aperture of the second CFRP layer and the groove of the foam may be arranged to coincide with each other. The steel plate may be stacked at an arrangement position on the second CFRP layer while allowing the weld nut having the temporary bolt temporarily fitted thereinto, to be integrally welded to the steel plate to be inserted through the aperture of the second layer. Then, the guide pins 54 may be fitted to fix a position of the steel plate. The third CFRP layer may be stacked, and the temporary bolt may be fitted into an aperture of the third CFRP layer. The upper mold may then be closed, and the resin may be injected. When air is discharged and a molded product is completed, the mold may be opened, the product may be removed, and the temporary bolt 53 may be removed. As described above, according to the exemplary embodiments, the CFRP plate that the weld nut may be molded integrally to may be manufactured, in a manner that a vehicle having the CFRP plate may be manufactured without significantly changing a manufacturing process.

While this disclosure has been described in connection with what is presently considered to be practical exemplary embodiments, it is to be understood that the present disclosure is not limited to the disclosed exemplary embodiments but on the contrary, is intended to cover various modifications and equivalent arrangements included within the spirit and scope of the accompanying claims. In addition, it is to be considered that all of these modifications and alterations fall within the scope of the present disclosure.

1. A CFRP plate formed by interposing a steel plate having a weld nut that is welded between CFRP layers adjacent to each other and injecting a resin when a temporary bolt is fitted into the weld nut.

2. The CFRP plate according to claim 1, wherein a foam is interposed between a layer on which the steel plate is disposed and a layer disposed below the layer on which the steel plate is disposed.

3. The CFRP plate according to claim 1, wherein guide pins are fitted into the steel plate and a second layer.

4. The CFRP plate according to claim 2, wherein guide pins are fitted into the steel plate, a second layer, and the foam.

5. The CFRP plate according to claim 1, wherein the weld nut is interposed between two layers when the weld nut is welded to a lower surface of the steel plate, and an aperture is formed in a portion of a second layer in which the weld nut is positioned.

6. The CFRP plate according to claim 2, wherein the weld nut is interposed between two layers wherein the weld nut is welded to a lower surface of the steel plate, an aperture is formed in a portion of a second layer in which the weld nut is positioned, and a groove that accommodates the weld nut therein is formed in the foam positioned below the aperture.

7. The CFRP plate according to claim 1, wherein a third layer has an aperture formed therein, the aperture having the temporary bolt penetrating therethrough.

8. The CFRP plate according to claim 1, wherein the temporary bolt is removed after the resin is injected.

9. A manufacturing method of the CFRP plate according to claim 1, comprising:
stacking at least two CFRP layers between a lower mold and an upper mold and interposing the steel plate to which the weld nut into which the temporary bolt is fitted is welded between the two layers;
closing the mold and injecting the resin; and
opening the mold and removing the temporary bolt, after the injecting of the resin.

10. The manufacturing method of the CFRP plate according to claim 9, wherein at least two CFRP layers are stacked with a foam interposed between the layer on which the steel plate is disposed and the layer disposed below the layer on which the steel plate is disposed.

11. The manufacturing method of the CFRP plate according to claim 9, wherein a guide pin is fitted into the steel plate and the second layer.

12. The manufacturing method of the CFRP plate according to claim 10, wherein a plurality of guide pins are fitted into the steel plate, the second layer, and the foam.

13. The manufacturing method of the CFRP plate according to claim 9, wherein the steel plate is stacked between the two layers having the weld nut fitted into an aperture of the portion of the second layer.

14. The manufacturing method of the CFRP plate according to claim 10, wherein the steel plate is stacked between the two layers having the weld nut fitted into an aperture of the portion of the second layer and a groove of the foam formed in a corresponding position to the aperture.

15. The manufacturing method of the CFRP plate according to claim 9, wherein a third layer has an aperture formed therein, the aperture having the temporary bolt penetrating therethrough.
